(19) United States
(12) Patent Application Publication
(10) Pub. No.: US 2020/0112649 A1
(43) Pub. Date: Apr. 9, 2020

(54) IMAGE READING DEVICE AND IMAGE FORMING APPARATUS

(71) Applicant: KONICA MINOLTA, INC., Tokyo (JP)

(72) Inventor: Tianzi XU, Tokyo (JP)

(73) Assignee: KONICA MINOLTA, INC., Tokyo (JP)

(21) Appl. No.: 16/589,857

(22) Filed: Oct. 1, 2019

(30) Foreign Application Priority Data
Oct. 9, 2018 (JP) 2018-190578

(51) Int. Cl. H04N 1/00

(52) U.S. Cl. CPC H04N 1/00819; H04N 1/00649; H04N 1/00588

(57) ABSTRACT

Disclosed is an image reading device including: a reader that reads an image on a continuous sheet; a conveying member that conveys the continuous sheet to a reading position; a calibration member that is movable to the reading position; a hardware processor that moves the conveying member and the calibration member so as to switch an arrangement between a first arrangement in which the continuous sheet directly faces the reader and a second arrangement in which the continuous sheet is located away from the reader and the calibration member directly faces the reader; and a pressing member that is disposed at the side of the reader parallel to a reading surface and that applies tension to the continuous sheet in the first arrangement so as to position a sheet surface of the continuous sheet at the reading surface.

### BACKGROUND

### Technological Field

The present invention relates to an image reading device and an image forming apparatus.

### Description of the Related Art

In recent years, since printing jobs of many types and small lots increase as compared with conventional mass printing jobs, it is necessary to handle orders in short delivery times. Even in small to medium label markets, production of many types of small-lot printed matters with stable printing quality are required by using digital production printers as engines. Therefore, there is proposed an image reading device which reads the color, position, magnification, and the like of an image on a sheet printed by a digital printer and feeds back the read information as a correction amount to the digital printer. The image reading device includes, for example, a scanner which includes a light source for emitting light to a sheet and a line sensor for reading information of reflected light from the sheet. Since the image reading device reads information in the width direction (line) orthogonal to the sheet conveyance direction at the reading position in the sheet conveyance direction, information in the sheet conveyance direction can be read by conveying the sheet. The scanner can inexpensively read images in a wide area at a speed faster than a colorimeter.

In order to improve the reading accuracy of the image reading device, a color calibration of the image reading device (a calibration for equalizing the unevenness in light intensity of the light source and the unevenness in sensitivity of the CCD sensor) is required. In the color calibration, a calibration member is disposed facing the reader of the image reading device and a calibration value is calculated from information obtained by the image reading device reading the calibration member.

Typically, the calibration member is disposed at the sheet reading position in many cases. When using cut sheets having a standard size, it is possible to perform a calibration between jobs. However, when using a continuous sheet such as a long sheet, the sheet remains to block the calibration member between jobs, which causes a problem that the color calibration cannot be performed simply. Meanwhile, many users require a printing operation is continuously performed until the final winding once the operation is started. This is because if the printing operation is stopped halfway, it is sometimes required to stitch printed parts together or a waste (spoilage) occurs due to a margin formed before the printing operation.

To cope with the problem, for example, JP 2017-112451A discloses an image forming apparatus for an elongated sheet. In order to calibrate an image reader, the long sheet is conveyed by a conveying member so as to pass through a gap between the image reader and a background member and not to pass through a gap between a color sample member and the image reader. Then, the image reader is moved or the background member, the color sample member, and the conveying member are moved so as to switch the arrangement between a first arrangement in which the image reader faces the background member with the elongated sheet interposed therebetween and a second arrangement in which the image reader faces the color sample member (the calibration member).

On the other hand, in order to stably and highly accurately read the color of an image by the image reading device, it is necessary to periodically perform a color calibration of the image reading device and to perform a reading operation with an accuracy in the range of ±1 mm with regard to the focal position in the vertical direction of the image reading device. However, in the configuration of JP 2017-112451A, the sheet may flap in the vertical direction at the reading position to cause a large color difference due to a change in the amount of reflected light at the exposure unit of the image reading device. Further, the vertical position of the sheet surface at the reading position differs depending on the thickness of the sheet. Therefore, the image on the continuous sheet cannot be read with high accuracy.

### SUMMARY

An object of the invention is to highly accurately and stably read an image on a continuous sheet.

To achieve at least one of the abovementioned objects, according to an aspect of the present invention, an image reading device reflecting one aspect of the present invention includes:

a reader that reads an image on a continuous sheet;

a conveying member that conveys the continuous sheet to a reading position facing the reader;

a calibration member that is movable to the reading position facing the reader;

a hardware processor that moves the conveying member and the calibration member so as to switch an arrangement between a first arrangement in which the continuous sheet directly faces the reader at the reading position and a second arrangement in which the continuous sheet is located away from the reader and the calibration member directly faces the reader between the reader and the continuous sheet; and

a pressing member that is disposed at at least one of an upstream side and a downstream side of the reader in the conveying direction of the continuous sheet parallel to a reading surface of the reader and that applies tension to the continuous sheet from a side facing the reader in the first arrangement so as to position a sheet surface on a side facing the reader of the continuous sheet passing through the reading position at the reading surface of the reader.

An image reading device reflecting another aspect of the present invention includes:

an image forming unit that forms an image on a continuous sheet; and

the above-described image reading device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention:

FIG. 1 is a diagram illustrating a schematic configuration of an image forming apparatus;

FIG. 2 is a block diagram illustrating a main functional configuration of the image forming apparatus;

FIG. 3A is a diagram illustrating a first arrangement of an image reading device;

FIG. 3B is a diagram schematically illustrating a second arrangement of the image reading device;

FIG. 4 is a diagram for describing a movement direction of a conveying member and a background member;

FIG. 5A is a diagram illustrating another example of the first arrangement of the image reading device;

FIG. 5B is a diagram illustrating another example of the second arrangement of the image reading device;

FIG. 6 is a flowchart illustrating a conveyance control process performed by a controller of FIG. 2;

FIG. 7A is a diagram for describing an arrangement of the background member; and

FIG. 7B is a diagram for describing an arrangement of the background member.

### DETAILED DESCRIPTION OF EMBODIMENTS

Hereinafter, one or more embodiments of the present invention will be described with reference to the drawings. However, the scope of the invention is not limited to the disclosed embodiments.

(Configuration of Image Forming Apparatus 100)

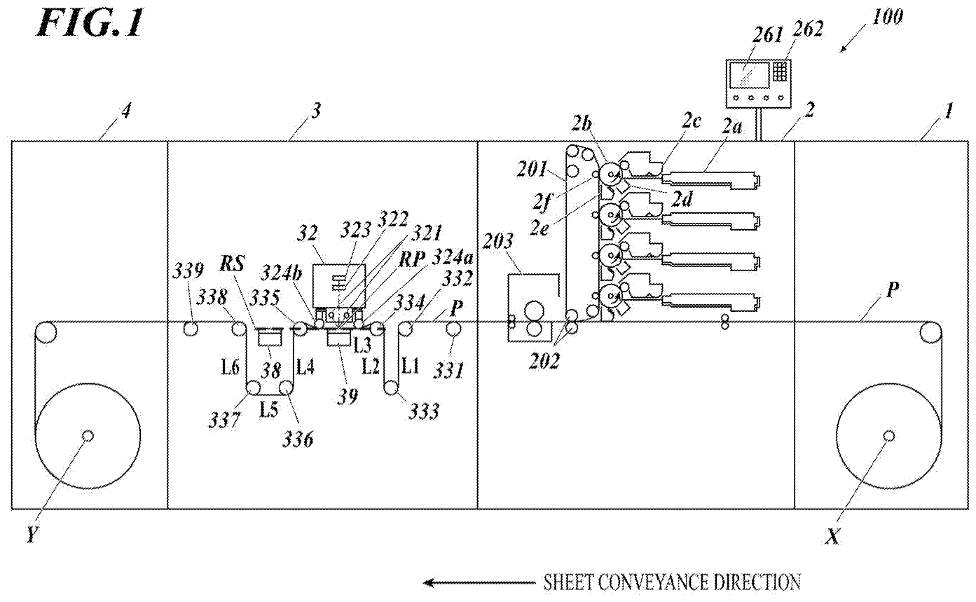

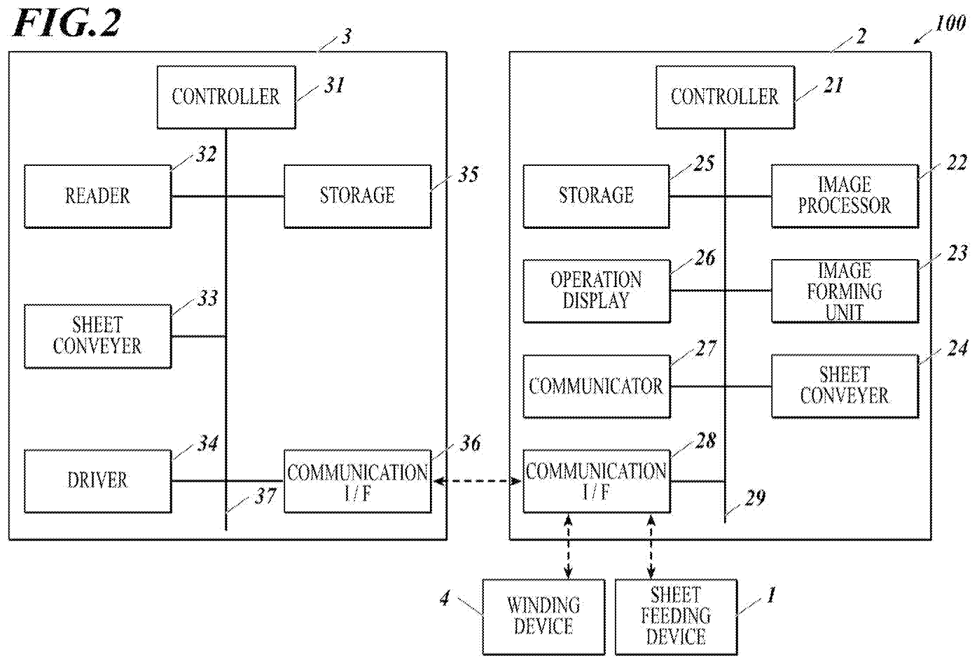

FIG. 1 is a front view of an image forming apparatus 100 according to an embodiment of the present invention, illustrating an example of the overall configuration thereof. FIG. 2 is a diagram illustrating a main part of a control system of the image forming apparatus 100. The image forming apparatus 100 is configured to form an image on a roll of continuous sheet P.

As illustrated in FIG. 1, the image forming apparatus 100 is configured such that a sheet feeding device 1, a main body 2, an image reading device 3, and a winding device 4 are connected in the written order from the upstream side in the conveying direction (the sheet conveyance direction) of the continuous sheet P.

The sheet feeding device 1 is configured to feed the continuous sheet P to the main body 2. The sheet feeding device 1 conveys the continuous sheet P wound on a support shaft X to the main body 2 at a constant speed through, for example, a plurality of conveying roller pairs such as a reel-out roller and a feeding roller. The feeding operation of the sheet feeding device 1 is controlled by a controller 21 of the main body 2.

The main body 2 forms an image by an intermediate transfer method based on electrophotography.

As illustrated in FIG. 2, the main body 2 includes the controller 21, an image processor 22, an image forming unit 23, a sheet conveyer 24, a storage 25, an operation display 26, a communicator 27, a communication I/F 28, and the like, and these units are connected to one another via a bus 29.

The controller 21 includes a central processing unit (CPU), a read only memory (ROM), a random access memory (RAM), and the like. The CPU of the controller 21 reads a program from the ROM in accordance with a required process, develops the program in the RAM, and integrally controls the operations of the sheet feeding device 1, the image reading device 3, the winding device 4, and the like as well as each block of the main body 2 in cooperation with the developed program.

The image processor 22 performs image processing such as density correction, rasterization, color conversion, and halftone processing on image data of a job input via the communicator 27 or the like and outputs the processed data to the image forming unit 23.

The image forming unit 23 includes four sets of subunits, each including an exposer 2a, a photoreceptor 2b, a developer 2c, a charger 2d, and a cleaner 2e, respectively corresponding to color components of yellow (Y), magenta (M), cyan (C), and black (K) along with a primary transfer roller 2f, an intermediate transfer member 201, a secondary transfer roller 202, and a fixing unit 203. The image forming unit 23 forms color toner images on the respective photoreceptors 2b on the basis of input image data, primarily transfers the color toner images on the intermediate transfer member 201 in a sequential order to superimpose four color toner images, and secondarily transfers the toner image onto the continuous sheet P fed from the sheet feeding device 1 by the secondary transfer roller 202 so that an image is formed on the continuous sheet P. Then, the formed image is fixed to the continuous sheet P by the fixing unit 203.

The sheet conveyer 24, which includes a plurality of conveying rollers and a drive source thereof, conveys the continuous sheet P conveyed from the sheet feeding device 1.

The storage 25 is constituted by, for example, a non-volatile semiconductor memory (so-called flash memory) or a hard disk drive. The storage 25 stores image data of an input job and setting information of the job. Alternatively, these data and the like may be stored in the RAM of the controller 21.

The operation display 26 is constituted by, for example, a liquid crystal display (LCD) with a touch panel and functions as a display 261 and an operation interface 262.

The display 261 displays various operation screens, image states, and operation states of various functions in accordance with a display control signal input from the controller 21.

The operation interface 262 includes various operation keys including a numerical pad and a start key and is configured to receive various user operations and output an operation signal to the controller 21.

The communicator 27, which is constituted by, for example, a communication control card such as a local area network (LAN) card, transmits and receives various data to and from an external device (for example, a personal computer) connected to a communication network such as a LAN and a wide area network (WAN).

The communication I/F 28 is provided for connection to the sheet feeding device 1, the image reading device 3, and the winding device 4.

The image reading device 3 reads an image on the continuous sheet P formed by the main body 2 to acquire a read image. The image reading device 3 includes, as illustrated in FIG. 2, a controller 31 (hardware processor), a reader 32, a sheet conveyer 33, a driver 34, a storage 35, a communication I/F 36, and the like, and these units are connected to one another by a bus 37. Further, the image reading device 3 includes a calibration member 38 and a background member 39.

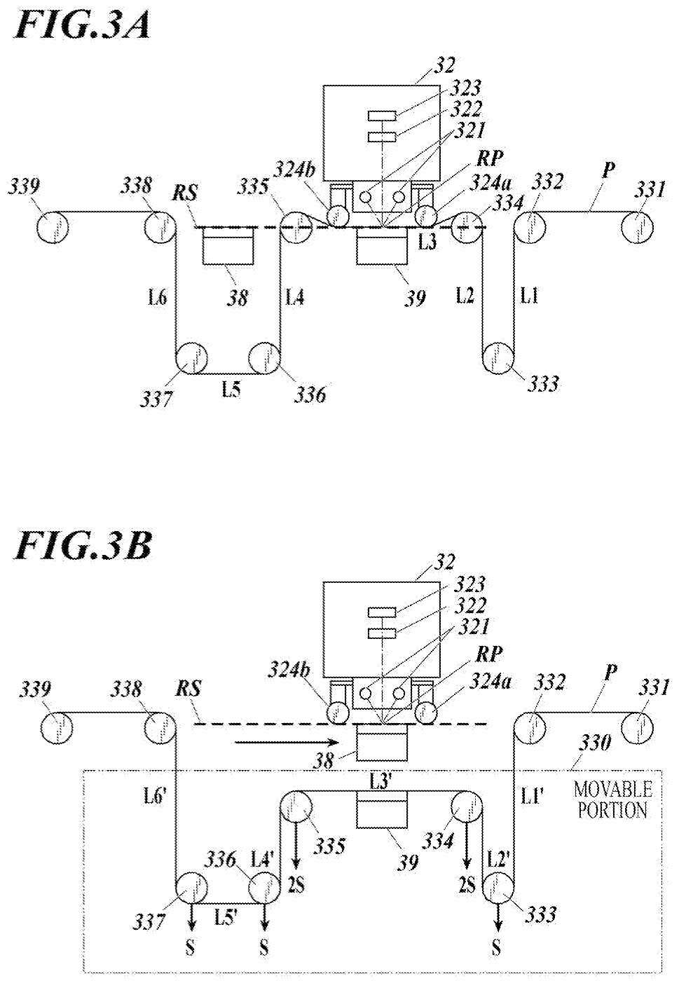

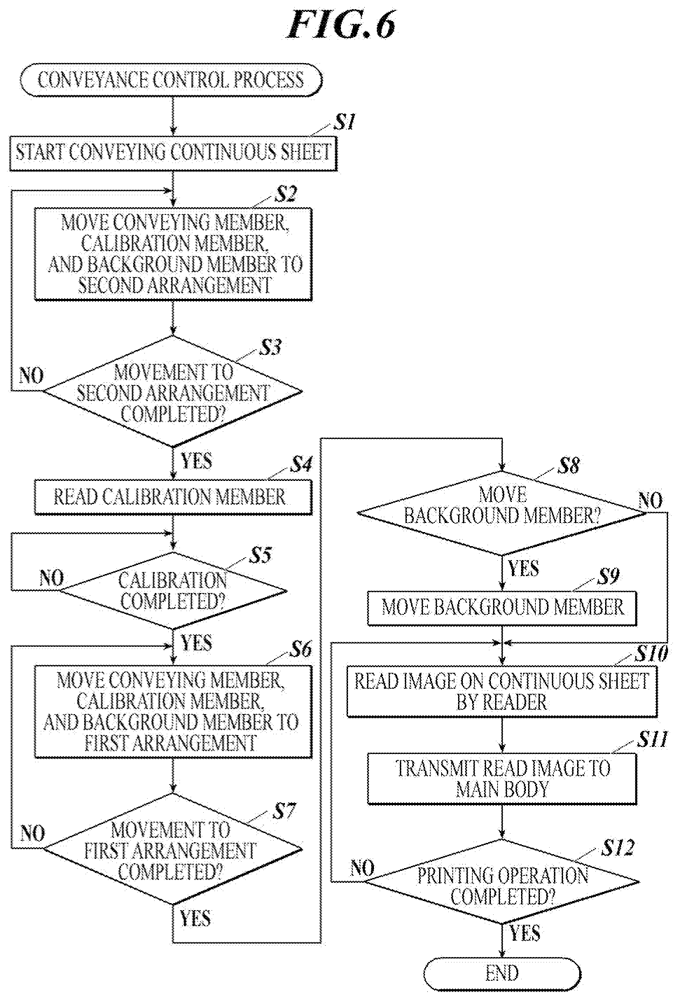

The controller 31 includes a central processing unit (CPU), a read only memory (ROM), a random access memory (RAM), and the like. The CPU of the controller 31 reads a program from the ROM in accordance with a required process, develops the program in the RAM, and integrally controls the operations of the blocks of the image reading device 3 on the basis of a control signal transmitted from the main body 2 in cooperation with the developed program. In the embodiment, the controller 31 performs a switching control process illustrated in FIG. 6 so as to switch the arrangement of the components of the image reading device 3 between a first arrangement illustrated in FIG. 3A and a second arrangement illustrated in FIG. 3B.

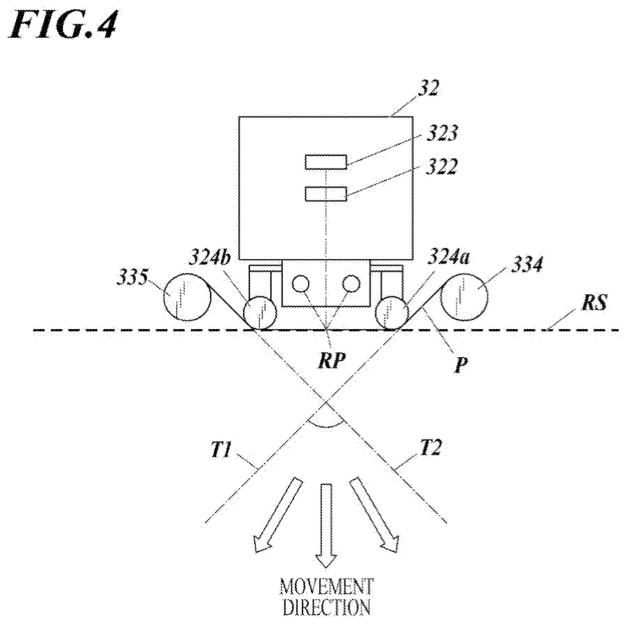

The image reading device 3 is in the first arrangement when the reader 32 reads the image on the continuous sheet P, in which the continuous sheet P directly faces the reader 32 at a reading position RP (a position intersecting the optical axis of the reader 32 in the sheet conveyance direction, see FIG. 4). The image reading device 3 is in the second arrangement when performing calibration of the reader 32, in which the continuous sheet P is separated from the reader 32, and the calibration member 38 is positioned between the reader 32 and the continuous sheet P at the reading position RP to directly face the reader 32.

The reader 32, which includes a light source 321, a lens 322, a CCD line sensor 323, and the like, is configured to optically scan the continuous sheet P conveyed from the main body 2 to the reading position RP, focus the light reflected from the continuous sheet P on a light receiving surface of the CCD line sensor 323 by the lens 322, and generate a read image by photoelectric conversion.

As illustrated in FIGS. 3A and 3B, a pressing member 324a (a first pressing member) and a pressing member 324b (a second pressing member) are provided respectively at the upstream side and the downstream side of the reader 32 in the sheet conveyance direction. The pressing members 324a and 324b are disposed in parallel to the reading plane RS of the reader 32 (a surface including the focus plane of the lens 322 at the reading position RP, a surface from which the reader 32 can most clearly read an image). In the first arrangement state, the pressing members 324a, 324b position the surface on the side facing the reader 32 of the continuous sheet P passing through the reading position RP at the reading plane RS of the reader 32 by tensioning the continuous sheet P from the reader 32.

As the pressing members 324a and 324b, for example, a roll, a roller, a bar-shaped member, and the like extending in a direction (main scanning direction) orthogonal to the sheet conveyance direction can be used. The material of the pressing members 324a and 324b are not particularly limited and, for example, metal or rubber can be used.

The sheet conveyer 33 includes, as illustrated in FIGS. 3A and 3B, for example, a plurality of conveying members 331 to 339 each including a conveying roller and the like. The sheet conveyer 33 conveys the continuous sheet P conveyed from the main body 2 along the sheet conveying path. The conveying members 331 to 339 are arranged in the numerical order from the upstream to the downstream in the sheet conveyance direction.

In the first arrangement, as illustrated in FIG. 4, a conveying member 334, which is adjacent to the pressing member 324a at the upstream side in the sheet conveyance direction, is positioned such that the contact portion of the conveying member 334 with the continuous sheet P is further away from the reading surface RS than the contact portion of the pressing member 324a with the continuous sheet P. Similarly, a conveying member 335, which is adjacent to the pressing member 324b at the downstream side in the conveyance direction, is positioned such that a contact portion of the conveying member 335 with the continuous sheet P is further away from the reading surface RS than a contact portion of the pressing member 324b with the continuous sheet P. In this configuration, the conveying member 334 can be further away from the reading surface RS than the pressing member 324a and can position the sheet surface at the reading surface RS regardless of the thickness of the sheet by tensioning the continuous sheet P at the reading position RP. As a result, an image can be read with high accuracy.

Further, conveying members 333 to 337 are movable in a direction perpendicular to the reading surface RS by the same driving source of the driver 34 and constitute a movable portion 330 (see FIG. 3B).

The driver 34 includes a driving source (a motor or the like) and a gear connected to an output shaft of the driving source which rotate the conveying members 331 to 339, move the background member 39 and the conveying members 333 to 337 of the movable portion 330 in a direction perpendicular to the reading surface RS, and move the calibration member 38 in a direction parallel to the reading surface RS. It is desirable that the same driving source moves the movable portion 330 and the background member 39 in a direction perpendicular to the reading surface RS. When different driving sources are used, it is necessary to synchronize respective operations. When the driver 34 moves the background member 39 and the conveying members 333 to 337 of the movable portion 330 in a direction perpendicular to the reading surface RS and moves the calibration member 38 in a direction parallel to the reading surface RS, the arrangement inside the image reading device 3 can be switched between the first arrangement illustrated in FIG. 3A and the second arrangement illustrated in FIG. 3B.

The calibration member 38 is a plate-shaped member having a white surface and used to calibrate the reader 32. The background member 39 is a plate-shaped member having a white surface and used as a reflection plate when an image on the continuous sheet P is read.

The switching of the first arrangement and the second arrangement will be described with reference to FIGS. 3A and 3B.

In the first arrangement illustrated in FIG. 3A, the reader 32 is positioned between the conveying members 334 and 335 in the sheet conveying path. The conveying members 331, 332, 334, 335, 338, and 339 are aligned in the vicinity of the reading surface RS substantially parallel to the reading surface RS. The conveying members 333, 336, and 337 are aligned at a position away from the reading surface RS parallel to the reading surface RS. By the conveying members 331 to 339 thus arranged, the continuous sheet P is conveyed so as to directly face the reader 32 at the reading position RP. Further, a U-shaped recess is formed in the sheet conveying path (a path between the conveying members 335 to 338) at the downstream of the reader 32 in the sheet conveyance direction. The calibration member 38 is disposed in the recess parallel to the reading surface RS. With the recess, the continuous sheet P is conveyed such that the continuous sheet P is not conveyed between the calibration member 38 and the reading surface RS. Alternatively, the recess and the calibration member 38 may be provided at the upstream of the reader 32 in the sheet conveyance direction. Further, the background member 39 is disposed at a position facing the reader 32 across the continuous sheet P, and an image on the conveyed continuous sheet P can be read by using the background member 39 as a background.

When the first arrangement illustrated in FIG. 3A is switched to the second arrangement illustrated in FIG. 3B, the controller 31 causes the driver 34 to move the background member 39 and the conveying members 333 to 337 of the movable portion 330 in a direction perpendicular to the reading surface RS and away from the reading surface RS (the reader 32). Then, the controller 31 causes the driver 34 to parallel-shift the calibration member 38 to the reading position RP so that the calibration member 38 directly faces the reader 32.

When the second arrangement illustrated in FIG. 3B is switched to the first arrangement illustrated in FIG. 3A, the controller 31 causes the driver to parallel-shift the calibration member 38 so that the calibration member 38 is disposed between the conveying members 335 and 338. Then, the controller 31 causes the driver 34 to move the background member 39 and the conveying members 333 to 337 of the movable portion 330 in a reverse direction to that in the switching to the second arrangement (a direction approaching the reading surface RS) so as to move them back to the first arrangement.

When switching between the first arrangement and the second arrangement, the controller 31 moves the conveying members 334 and 335 close to the reader 32 (the reading surface RS) (the conveying members 334 and 335 at a first distance from the reading surface RS) by a distance 2S at the same speed while moving the conveying members 333, 336, and 337 away from the reader 32 (the reading surface RS) (the conveying members 333, 336, and 337 at a second distance from the reading surface RS (the first distance<the second distance)) by a distance S at half the speed of the conveying members 334 and 335.

Where L is the entire length of the conveying path from the conveying member 332 adjacent to the upstream side in the sheet conveyance direction of the movable portion 30 at the first arrangement to the conveying member 338 adjacent to the downstream side in the sheet conveyance direction of the movable portion 30, L1 is the length of the conveying members 332 to 333, L2 is the length of the conveying members 333 to 334, L3 is the length of the conveying members 334 to 335, L4 is the length of the conveying members 335 to 336, L5 is the length of the conveying members 336 to 337, and L6 is the length of the conveying members 337 to 338 is denoted by L6, L is represented by the following equation.

L=L1+L2+L3+L4+L5+L6

Further, where L′ is the entire length of the conveying path of the conveying members 332 to 338 at the second arrangement (or in the conveying state), L1′ is the length of the conveying members 332 to 333, L2′ is the length of the conveying members 333 to 334, L3′ is the length of the conveying members 334 to 335, L4′ is the length of the conveying members 335 to 336, L5′ is the length of the conveying members 336 to 337, and L6′ is the length of the conveying members 337 to 338, L′ is represented by the following equation.

L′=L1′+L2′+L3′+L4′+L5′+L6′

Since L1′=L1+S, L2′=L2+S−2S=L2−S, L3′=L3, L4′=L4+S−2S=L4−S, L5′=L5, and L6′=L6+S, L′ is represented by the following equation.

$$\begin{matrix}{L}^{′} = L 1 + S + L 2 - S + L 3 + L 4 - S + L 5 + L 6 + S \\ = L 1 + L 2 + L 3 + L 4 + L 5 + L 6 = L\end{matrix}$$

That is, since the conveying members 334 and 335 close to the reader 32 (the reading surface RS) are moved by a distance 2S at the same speed while the conveying members 333, 336, and 337 away from the reader 32 (the reading surface RS) are moved by a distance S at half the speed of the conveying members 334 and 335, the sheet path length can be kept substantially constant at least at a portion from the conveying member adjacent to the upstream side of the movable portion 330 in the sheet conveyance direction to the conveying member adjacent to the downstream side of the movable portion 330 in the sheet conveyance direction from start to end of the process of switching between the first arrangement and the second arrangement.

In the image forming apparatus 100 for the continuous sheet P, the tension of the sheet is changed if the sheet path length is changed in the course of the path. Accordingly, the sheet is torn or the sheet needs to be pulled to the upstream or downstream side. That is, the upstream and downstream devices are adversely influenced. In the image reading device 3 of the embodiment, since the sheet path length from the conveying member adjacent to the upstream side of the movable portion 330 in the sheet conveyance direction to the conveying member adjacent to the downstream side of the movable portion 330 in the sheet conveyance direction is controlled to be substantially constant (that is, the sheet path length of the entire sheet conveying path is not changed) even from start to end of the process of switching between the first arrangement and the second arrangement in which the sheet conveying path is moved, it is possible to switch between the first arrangement and the second arrangement without giving an adverse influence on the upstream and downstream devices.

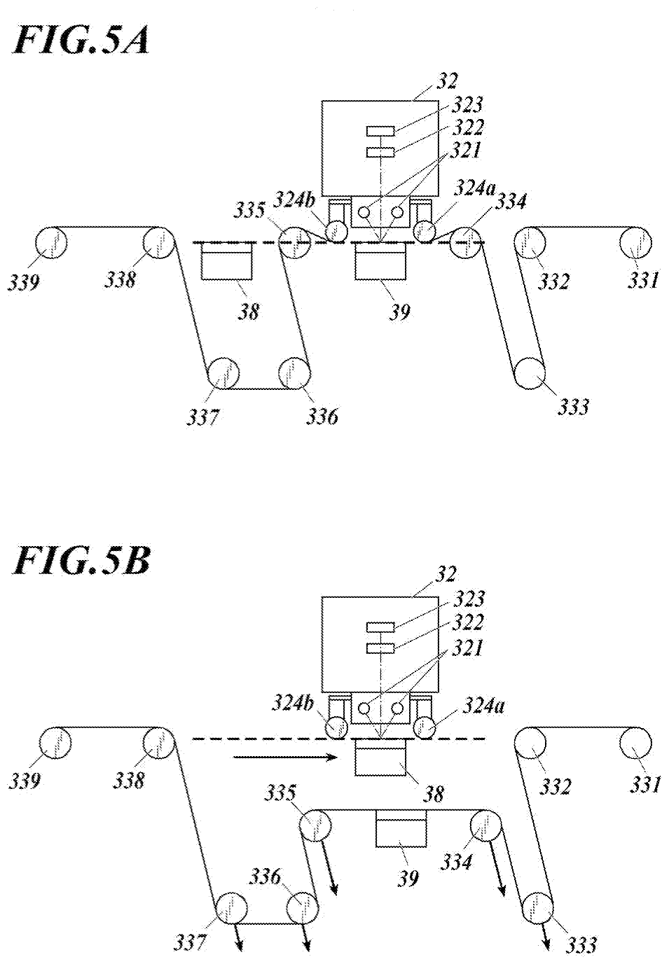

FIGS. 3A and 3B illustrate an example in which the background member 39 and the conveying members 333 to 337 of the movable portion 330 are moved in a direction perpendicular to the reading surface RS is illustrated, but the movement direction of the background member 39 and the conveying members 333 to 337 of the movable portion 330 is not limited to the perpendicular direction but may be a diagonal direction as illustrated in FIGS. 5A and 5B. However, the movement direction of the background member 39 and the conveying members 333 to 337 of the movable portion 330 is desirably between the common internal tangent T1 of the conveying member 334 and the pressing member 324a extending toward the distal end (side closer to the reading surface RS) of the pressing member 324a, and the common internal tangent T2 of the conveying member 335 and the pressing member 324b extending toward the distal end (side closer to the reading surface RS) of the pressing member 324b in the first arrangement as illustrated in FIG. 4 (for example, any of the directions indicated by the arrows illustrated in FIG. 4 but not including the tangent directions) in a cross-sectional front view of the image reading device 3. When the movement direction is within this range, it is possible to prevent the conveying members 334 and 335 from colliding with (interfering with) the pressing members 324a and 324b or the reader 32.

The storage 35 is configured as a non-volatile memory or the like and stores an image read by the reader 32 or a calibration value of the reader 32.

The communication I/F 36 is provided for connection to the sheet feeding device 1, the image reading device 3, and the winding device 4.

The winding device 4 winds the continuous sheet P conveyed from the image reading device 3 on a support shaft Y at a constant speed after passing the continuous sheet P through a plurality of conveying roller pairs (for example, an input roller and a discharge roller). The winding operation of the winding device 4 is controlled by the controller 21 of the main body 2.

(Operation of Image Reading Device 3)

Next, an operation of the image reading device 3 will be described.

FIG. 6 is a flowchart of a switching control process performed by the controller 31. The switching control process is performed in response to receiving a signal indicating the start of a printing operation (conveying operation of the continuous sheet P) from the main body 2.

First, the controller 31 rotates the conveying members 331 to 339 of the sheet conveyer 33 by the driver 34 so as to start conveying the continuous sheet P (step S1).

Next, the controller 31 moves the background member 39, the calibration member 38, and the conveying members 333 to 337 of the movable portion 330 to the second arrangement by the driver 34 (step S2).

That is, the controller 31 moves the background member 39 and the conveying members 333 to 337 of the movable portion 330 away from the reading surface RS (the reader 32) in a direction perpendicular to the reading surface RS by the driver 34. Then, the controller 34 shifts the calibration member 38 to the reading position RP by the driver 34 so that the calibration member 38 directly faces the reader 32.

When the movement to the second arrangement is completed (step S3; YES), the controller 31 reads the calibration member 38 by the reader 32 (step S4).

Next, the controller 31 performs a calibration process of calculating a calibration value from the image read by the reader 32. Then, when the calibration process is completed (step S5; YES), the controller 31 moves the background member 39, the calibration member 38, and the conveying members 333 to 337 of the movable portion 330 to the first arrangement by the driver 34 (step S6).

That is, the controller 31 shifts the calibration member 38 by the driver 34 so that the calibration member 38 is disposed between the conveying members 335 and 338. Then, the controller 31 moves the background member 39 and the conveying members 333 to 337 of the movable portion 330 in a reverse direction to that in the switching to the second arrangement (a direction approaching the reading surface RS) by the driver 34 so that the continuous sheet P directly faces the reader 32.

When the movement to the first arrangement is completed (step S7; YES), the controller 31 determines whether to move the background member 39 on the basis of the color of the continuous sheet P (step S8).

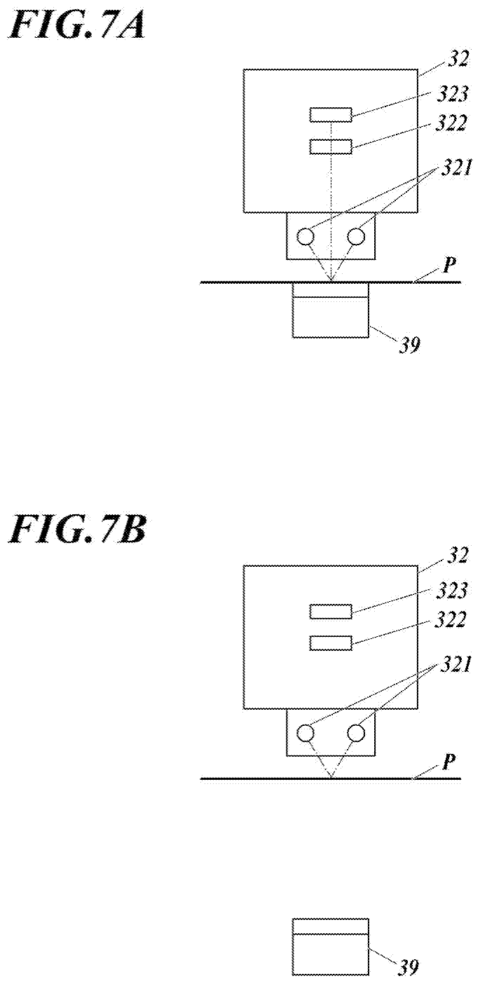

As illustrated in FIG. 7A, if a sheet is read by the reader 32 when the background member 39 is positioned in the vicinity of the reading surface RS, a read image to be obtained has a white background since light emitted from the light source 321 is reflected by the white background member 39. As illustrated in FIG. 7B, if a sheet is read by the reader 32 when the background member 39 is located at a predetermined distance or more away from the reading surface RS, a read image to be obtained has a black background since the light emitted from the light source is not reflected. Based on this, the controller 31 determines to move the background member 39 to a position a predetermined distance or more away from the reading surface RS if the sheet color of the conveyed continuous sheet P is within a predetermined color range close to white. The controller 31 determines not to move the background member 39 if the sheet color of the continuous sheet P is within a predetermined color range close to black. This can make the edge of the sheet stand out from the background and thereby make the position adjustment of the sheet based on the read image easier. Additionally, the pressing members 324a and 324b are omitted in FIGS. 7A and 7B.

If it is determined to move the background member 39 (step S8; YES), the controller 31 moves the background member 39 to a position a predetermined distance or more away from the reading surface RS by the driver 34 (step S9) and proceeds to step S10. If it is determined not to move the background member 39 (step S8; NO), the controller 31 proceeds to step S10.

In step S10, the controller 31 reads the continuous sheet P by the reader 32 (step S10) and transmits the read image to the main body 2 via a communication I/F 36 (step S11).

In the main body 2, calibration values of color, position, and magnification of images are calculated on the basis of the read image transmitted from the image reading device 3 and are fed back to an image forming operation.

Next, the controller 31 determines whether a printing operation of the main body 2 has ended (step S12).

When it is determined that the printing operation of the main body 2 has not ended yet (step S12; NO), the controller 31 returns a routine to step S10.

When it is determined that the printing operation of the main body 2 has ended (step S12; YES), the controller 31 ends the switching control process.

As described above, since the image reading device 3 can switch between the first arrangement in which the reader 32 directly faces the continuous sheet P and the second arrangement in which the reader 32 directly faces the calibration member 38 without changing the sheet conveying path length, it is possible to switch between the first arrangement and the second arrangement while conveying the continuous sheet P after a printing operation is started. Then, in the switching control process, the controller 31 starts a printing operation and controls the switching between the first arrangement and the second arrangement while conveying the continuous sheet P. If a calibration is performed before the printing operation of the continuous sheet P is started, it takes an unnecessary time. However, the front part of the continuous sheet P is a blank sheet having no image formed thereon at the time of starting the printing operation on the continuous sheet P. In the switching control process, since the calibration member 38 is read at the time of starting the printing operation when the blank sheet is passing through the image reading device 3, it is possible to reduce the unnecessary time for the calibration and to efficiently perform a printing operation and a calibration.

As described above, in the image reading device 3, the controller 31 moves the conveying members 333 to 337 and the calibration member 38 so as to control the switching between the first arrangement in which the continuous sheet P directly faces the reader 32 at the reading position RP and the second arrangement in which the continuous sheet P is away from the reader 32 and the calibration member 38 directly faces the reader 32 between the reader 32 and the continuous sheet P and. Further, the pressing members 324a and 324b are provided at the upstream and downstream sides of the reader 32 in the conveying direction of the continuous sheet P in parallel to the reading surface RS of the reader 32 to apply a tension to the continuous sheet P from the side facing the reader 32 in the first arrangement so that the sheet surface on the side facing the reader 32 of the continuous sheet P passing through the reading position RP is positioned on the reading surface RS.

Accordingly, since the calibration member 38 can directly face the reader 32 even when the continuous sheet P is used, the reader 32 can be calibrated. Further, since the continuous sheet P is tensioned by the pressing members 324a and 324b so that the continuous sheet P is positioned on the reading surface RS at the reading position RP, an image formed on the continuous sheet P can be read with high accuracy.

Further, in the first arrangement, the conveying members 334 and 335 adjacent to the pressing members 324a and 324b are positioned at the same side as the pressing members 324a and 324b with respect to the reading surface RS, and the portions in contact with the continuous sheet P of the conveying members 334 and 335 adjacent to the pressing members 324a and 324b are located further away from the reading surface RS than the portions in contact with the continuous sheet P of the pressing members 324a and 324b.

Accordingly, since the continuous sheet P can be reliably tensioned at the reading position RP, it is possible to position the sheet surface on the reading surface RS regardless of the thickness of the continuous sheet P and hence to read an image formed on the continuous sheet P with higher accuracy.

Further, when switching from the first arrangement to the second arrangement, the controller 31 controls the conveying members 333 to 337 so that the movement direction thereof is between the common internal tangent T1 of the conveying member 334 adjacent to the pressing member 324a and the pressing member 324a extending toward the distal end of the pressing member 324a, and the common internal tangent T2 of the conveying member 335 adjacent to the pressing member 324b and the pressing member 324b extending toward the distal end of the pressing member 324b in the first arrangement.

Accordingly, it is possible to prevent the conveying member 334 (335) and the pressing member 324a (324b) from (colliding) interfering with each other when the arrangement is switched between the first arrangement and the second arrangement.

Further, since the plurality of movable conveying members 333 to 337 constitutes the movable portion 330 and all conveying members of the movable portion 330 are movable in the same direction, the control can be easily performed.

Further, the controller 31 moves the conveying members 333 to 337 of the movable portion 330 such that at least the sheet path length from the conveying member 332 adjacent to the upstream side of the movable portion 330 in the conveying direction of the continuous sheet P to the conveying member 338 adjacent to the downstream side of the movable portion 330 in the conveying direction of the continuous sheet P remain substantially the same even from start to end of the switching between the first arrangement and the second arrangement. For example, the controller 31 performs the control so that the moving distance of the conveying members 334 and 335 at a first distance from the reading surface RS becomes twice the moving distance of the conveying members 333, 336, and 337.

Accordingly, it is possible to switch between the first arrangement and the second arrangement without giving an adverse influence on the upstream and downstream devices.

Further, the controller 31 switches the arrangement between the first arrangement and the second arrangement while conveying the continuous sheet P by the sheet conveyer 33.

Accordingly, it is possible to perform a calibration in the course of the printing operation on the continuous sheet P and thereby to reduce a time until the end of the printing operation.

Further, the calibration member 38 is disposed at the upstream or downstream side of the reader 32 in the conveying direction parallel to the reading surface RS in the first arrangement, and the controller 31 switches the arrangement from the first arrangement state to the second arrangement by moving the conveying members 333 to 337 so that the continuous sheet P is separated from the reader 32 and shifting the calibration member 38 to a position facing the reader 32. Accordingly, the calibration member 38 can be moved with a simple configuration.

Further, the white background member 39 is provided that is disposed at a position facing the reader 32 across the continuous sheet P in the first arrangement, and the distance between the background member 39 and the continuous sheet P is changeable. Accordingly, since the background of the continuous sheet P can be read as white by decreasing the distance between the continuous sheet P and the background member 39 of the background of the continuous sheet P can be read as black by increasing the distance between the continuous sheet P and the background member 39, it is possible to easily recognize the edge of different colors of continuous sheets P.

Additionally, the above-described embodiment is a preferred example of the invention, and the invention is not limited thereto.

For example, the above-described embodiment illustrates an example in which the image reading device 3 includes nine conveying members, but the invention is not limited thereto.

Further, the calibration of the position of the continuous sheet P may be performed by, for example, using a sensor or the like provided in the main body 2. In this case, the background member 39 may not be provided.

Further, the above-described embodiment illustrates an example in which the image forming apparatus 100 is a color image forming apparatus that sequentially transfers toner images on photoreceptors onto a transfer member. However, the image forming apparatus may be a tandem-type color image forming apparatus in which a plurality of image carriers of respective colors are arranged in series on an intermediate transfer member or a monochrome image forming apparatus which forms an image with a single color toner.

In addition, the detailed configuration and the detailed operation of the image forming apparatus can be appropriately modified without departing from the scope of the invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-190578 filed on Oct. 9, 2018 is incorporated herein by reference in its entirety.

What is claimed is:

1. An image reading device, comprising:
a reader that reads an image on a continuous sheet;
a conveying member that conveys the continuous sheet to a reading position facing the reader;
a calibration member that is movable to the reading position facing the reader;
a hardware processor that moves the conveying member and the calibration member so as to switch an arrangement between a first arrangement in which the continuous sheet directly faces the reader at the reading position and a second arrangement in which the continuous sheet is located away from the reader and the calibration member directly face the reader between the reader and the continuous sheet; and
a pressing member that is disposed at at least one of an upstream side and a downstream side of the reader in the conveying direction of the continuous sheet parallel to a reading surface of the reader and that applies tension to the continuous sheet from a side facing the reader in the first arrangement so as to position a sheet surface on a side facing the reader of the continuous sheet passing through the reading position at the reading surface of the reader.

2. The image reading device according to claim 1, wherein in the first arrangement, the conveying member adjacent to the pressing member is located at a same side as the pressing member with respect to the reading surface, and a portion in contact with the continuous sheet of the conveying member adjacent to the pressing member is located further away from the reading surface than a portion in contact with the continuous sheet of the pressing member.

3. The image reading device according to claim 1,
wherein the pressing member includes a first pressing member disposed at an upstream side of the reading position in the conveying direction of the continuous sheet and a second pressing member disposed at a downstream side of the reading position in the conveying direction of the continuous sheet, and
wherein the conveying member includes an upstream conveying member adjacent to the first pressing member and a downstream conveying member adjacent to the second pressing member, and
wherein in switching from the first arrangement to the second arrangement, the hardware processor controls the conveying member so that movement direction of the conveying member is between a common internal tangent of the upstream conveying member and the first pressing member extending toward a distal end of the first pressing member and a common internal tangent of the downstream conveying member and the second pressing member extending toward a distal end of the second pressing member in the first arrangement.

4. The image reading device according to claim 1,
wherein the conveying member includes a movable portion composed of a plurality of movable conveying members, and
wherein the plurality of conveying members of the movable portion are movable in a same direction.

5. The image reading device according to claim 4, wherein the hardware processor moves the plurality of conveying members of the movable portion such that a sheet path length at least from a conveying member adjacent to an upstream of the movable portion in the conveying direction of the continuous sheet to a conveying member adjacent to a downstream of the movable portion in the conveying direction of the continuous sheet remains substantially same from start to end of switching between the first arrangement and the second arrangement.

6. The image reading device according to claim 5,
wherein the plurality of conveying members of the movable portion is composed of a first conveying member at a first distance from the reading surface and a second conveying member at a second distance from the reading surface, in which the second distance is greater than the first distance, and
wherein the hardware processor controls the plurality of conveying members of the movable portion such that a moving distance of the first conveying member is twice a moving distance of the second conveying member.

7. The image reading device according to claim 1, wherein the hardware processor switches the arrangement between the first arrangement and the second arrangement while conveying the continuous sheet by the conveying member.

8. The image reading device according to claim 1,
wherein in the first arrangement, the calibration member is disposed at an upstream or downstream of the reader in the conveying direction and parallel to the reading surface, and
wherein in switching to the second arrangement, the hardware processor moves the conveying member from the first arrangement to separate the continuous sheet away from the reader and thereafter shifts the calibration member to a position facing the reader.

9. The image reading device according to claim 1, further comprising:
a white background member that is disposed at a position facing the reader across the continuous sheet in the first arrangement,
wherein a distance between the background member and the continuous sheet is changeable.

10. An image forming apparatus comprising:
an image forming unit that forms an image on a continuous sheet; and
the image reading device according to claim 1.
